(19) United States
(12) Patent Application Publication
(10) Pub. No.: US 2023/0206354 A1
(43) Pub. Date: Jun. 29, 2023

(54) INFORMATION PROCESSING APPARATUS, INFORMATION PROCESSING METHOD, AND COMPUTER-READABLE MEDIUM

(71) Applicant: NTT Communications Corporation, Tokyo (JP)

(72) Inventors: Akira SAKAINO, Tokyo (JP); Hideaki NIITSUMA, Yokohama-shi (JP); Yoichi SUZUKI, Funabashi-shi (JP); Masataka ITO, Chigasaki-shi (JP)

(73) Assignee: NTT Communications Corporation, Tokyo (JP)

(21) Appl. No.: 18/057,012

(22) Filed: Nov. 18, 2022

Related U.S. Application Data
(63) Continuation of application No. PCT/JP2021/020049, filed on May 26, 2021.

(30) Foreign Application Priority Data
May 26, 2020 (JP) 2020-091781

(51) Int. Cl. G06Q 50/04; G06Q 30/018

(52) U.S. Cl. CPC G06Q 50/04; G06Q 30/018

(57) ABSTRACT

An aspect of an information processing apparatus according to this invention includes an acquisition unit that acquires management information including power information related to one or more types of electric power used in a manufacturing process of a product or component among a plurality of types of electric power of different power generating systems, a calculation unit that calculates a first carbon dioxide emission amount emitted through manufacturing of the product or component based on the power information included in the management information, and an output unit that outputs information related to the first carbon dioxide emission amount.

### CROSS REFERENCE TO RELATED APPLICATIONS

This application is a Continuation Application of PCT Application No. PCT/JP2021/020049, filed May 26, 2021 and based upon and claiming the benefit of priority from Japanese Patent Application No. 2020-091781, filed May 26, 2020, the entire contents of all of which are incorporated herein by reference.

### FIELD

The present invention relates generally to an information processing apparatus, an information processing method, and a program thereof for outputting information related to an emission amount of carbon dioxide (CO₂) emitted in a manufacturing process of a product or component.

### BACKGROUND

Solution businesses that support the circular economy are emerging, mainly in Europe. It is said that in Japan, since 2020, there are some manufacturing companies that have taken steps in large-scale investment for the circular economy, and there is a demand for technology that contributes to the circular economy through technology services based on the telecommunications business.

### CITATION LIST

### Patent Literature

Patent Literature 1: Japanese Patent Application KOKAI Publication No. 2004-310440

### SUMMARY

### Technical Problem

If electric power is consumed in a manufacturing process of a product or component, CO₂ is emitted to obtain the electric power. Various power generating systems such as thermal power generation, hydraulic power generation, wind power generation, and solar power generation are known. The CO₂ emission amount varies depending on the power generating system. For example, power generation relying on fossil fuels increases CO₂ emissions, but power generation using renewable energies can reduce the CO₂ emission amount to nearly 0. If the source of the electric power is not taken into account, the CO₂ emission amount can be calculated or predicted based on an actual or predicted power consumption amount. However, since such calculation or prediction is different from reality, there is a demand to know the CO₂ emission amount in consideration of the source of the electric power. In solution businesses that support the circular economy, more detailed information related to the CO₂ emission amount is required.

This invention is made in response to the above circumstances and attempts to provide a technology for outputting information related to a substantive emission amount of CO₂ emitted in a manufacturing process of a product or component.

### Solution to Problem

To solve the above-described problem, one aspect of an information processing apparatus according to the present invention includes an acquisition unit that acquires management information including power information related to one or more types of electric power used in a manufacturing process of a product or component among a plurality of types of electric power of different power generating systems, a calculation unit that calculates a first carbon dioxide emission amount emitted through manufacturing of the product or component based on the power information included in the management information, and an output unit that outputs information related to the first carbon dioxide emission amount.

### Advantageous Effects of Invention

According to an aspect of the present invention, a technology for outputting information related to a substantive emission amount of CO₂ emitted in a manufacturing process of a product or component can be provided.

### BRIEF DESCRIPTION OF THE DRAWINGS

FIG. 1 is a block diagram showing an example of an information processing system according to an embodiment.

FIG. 2 is a block diagram showing an example of a schematic configuration of an information processing apparatus according to the embodiment.

FIG. 3 is a functional block diagram showing an example of a processor of the information processing apparatus according to the embodiment.

FIG. 4 is a diagram showing an example of a data platform, etc. stored in an auxiliary storage unit of the information processing apparatus according to the embodiment.

FIG. 5 is a block diagram showing an example of a schematic configuration of an information output system of a plant according to the embodiment.

FIG. 6 is a flowchart showing an example of information processing including CO₂ emission amount calculation performed by the information processing apparatus according to the embodiment.

### DETAILED DESCRIPTION

An embodiment according to the present invention will be described below with reference to the drawings.

### (Summary)

An information processing system according to the embodiment creates and stores usage history information by power type for machine tools, conveying machines, transport vehicles, etc. actually used in each process from manufacturing to reuse in a manufacturing process of a product or component that can selectively use a plurality of types of electric power of different power generating systems (including a manufacturing process using a reused product), and calculates a CO₂ emission amount directly or indirectly emitted through manufacturing of each and every product or component based on the stored usage history information.

Furthermore, if the power type can be selected for each manufacturing sub-process included in the manufacturing process, the information processing system creates and stores usage history information indicating which power type is selected and used in which time zone by manufacturing sub-process, and calculates a CO₂ emission amount for all processes, manufacturing processes, or manufacturing sub-processes based on this usage history information.

This makes it possible to calculate, record, trace, and verify an accurate CO₂ emission amount for each product or component no matter what type of electric power is selected for use in the manufacturing process. In addition, even if the manufacturing process is composed of a plurality of sub-processes and each sub-process selects and uses any power type, the CO₂ emission amount can be accurately calculated, recorded, traced, and verified.

Further, a price of the product or component may be calculated based on the CO₂ emission amount according to the power type used in the manufacturing process, and information of the price of the product or component may be output together with the CO₂ emission amount. If the power type used in the manufacturing process is different, the price of the same product or component will be different due to an influence of an environmental impact equivalent amount determined based on the CO₂ emission amount according to the power type. For example, a price of a product or component manufactured using electric power having a large CO₂ emission amount tends to be higher than that of a product or component manufactured using electric power having a small CO₂ emission amount. A user can select or purchase a product by referring to the CO₂ emission amounts and prices.

Further, a price of a product or component may be calculated based on a CO₂ emission amount according to the power type used in a manufacturing process and a CO₂ emission amount according to the kind of raw material, and information of the price of the product or component may be output together with the CO₂ emission amount. For example, a price of a product or component manufactured using a virgin raw material having a large CO₂ emission amount is higher than that of a product or component manufactured using a recycled raw material having a small CO₂ emission amount. Also in this case, the user can select or purchase a product by referring to the CO₂ emission amounts and prices.

### (Configuration Example)

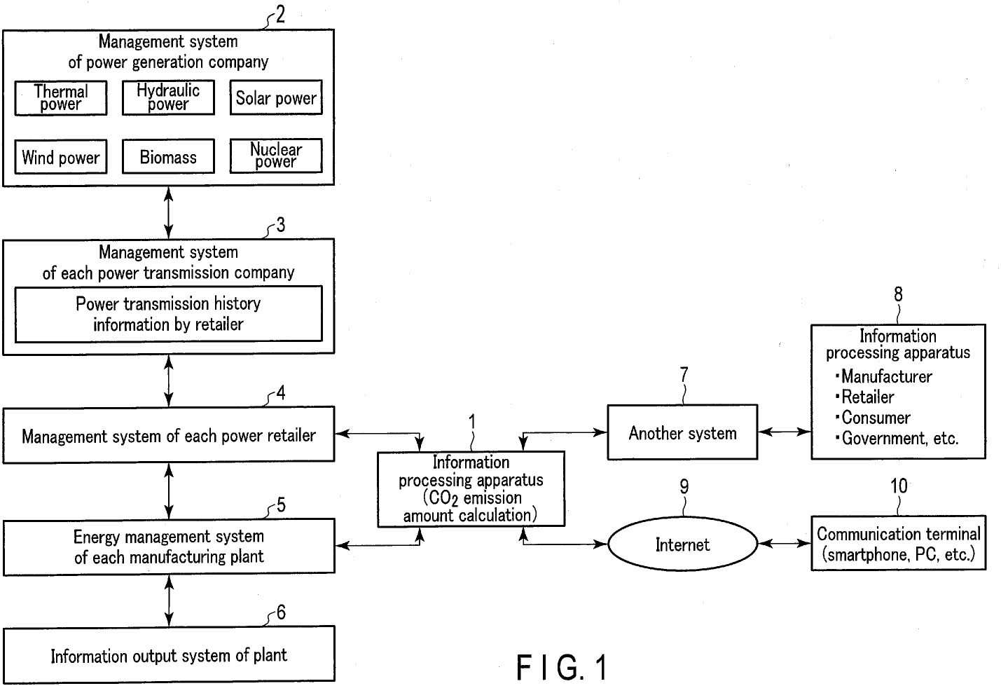

FIG. 1 is a block diagram showing an example of an information processing system according to an embodiment.

As shown in FIG. 1, the information processing system includes an information processing apparatus 1 that calculates a CO₂ emission amount. The information processing apparatus 1 directly or indirectly communicates with a management system 2 of each power generation company, a management system 3 of each power transmission company, a management system 4 of a power retailer, an energy management system 5 of a manufacturing plant, and an information output system 6 of a plant, and transmits and receives information to and from each system.

For example, each power generation company supplies a plurality of types of electric power such as thermal power, hydraulic power, solar power, wind power, biomass, and nuclear power, and the management system 2 of each power generation company transmits a plurality of types of power generation information such as thermal power, hydraulic power, solar power, wind power, biomass, and nuclear power. The power generation information includes information such as a type of electric power, an amount of electric power, a region, and a supply time zone. The management system 3 of each power transmission company receives the power generation information from the management system 2 of each power generation company, generates power transmission history information by retailer based on the power generation information, and transmits the power transmission history information. The management system 4 of the power retailer receives the power transmission history information, generates power sales history information based on the power transmission history information, and transmits the power sales history information. The energy management system 5 of the manufacturing plant generates energy information including power purchase history information, power consumption history information, and fuel consumption history information based on various types of information from the information output system 6 of the plant, and transmits the energy information.

The information processing apparatus 1 receives the power sales history information from the management system 4 of the power retailer, receives the energy information from the energy management system 5 of the manufacturing plant, and generates management information from the power sales history information and the energy information. The management information includes raw material information related to one or more kinds of raw materials used in the manufacturing process of the product or component, power information related to one or more types of electric power, and fuel information related to one or more kinds of fuels.

In addition, the information processing apparatus 1 transmits and receives information to and from an information processing apparatus 8 of a manufacturer, a sales company, a consumer, the government, or the like via another system 7. Furthermore, the information processing apparatus 1 communicates with a communication terminal 10 such as a smartphone or a personal computer of each person via a communication network 9 such as the Internet, and transmits and receives information to and from the communication terminal 10.

Each device and each system shown in FIG. 1 can be realized by, for example, a general-purpose computer or a specially-designed computer including a processor, a main storage unit, an auxiliary storage unit, a communication interface, an input/output interface, etc.

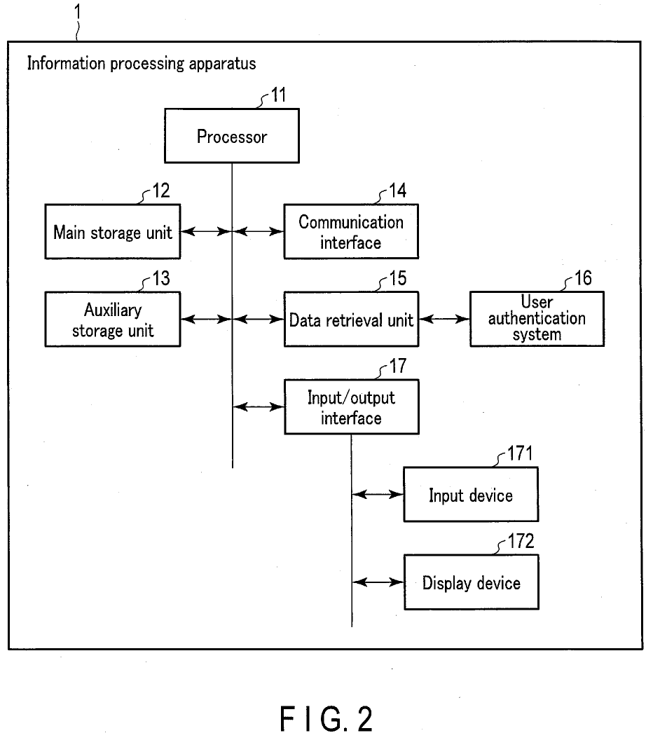

FIG. 2 is a block diagram showing a schematic configuration of the information processing apparatus 1 according to the embodiment.

As shown in FIG. 2, the information processing apparatus 1 includes a processor 11, a main storage unit 12, an auxiliary storage unit 13, a communication interface 14, a data retrieval unit 15, a user authentication system 16, and an input/output interface 17. Further, the information processing apparatus 1 includes an input device 171 and a display device 172 connected to the input/output interface 17.

The processor 11 is a central processing unit (CPU), a micro processing unit (MPU), or a digital signal processor (DSP). Alternatively, the processor 11 is a combination of two or more of them. The processor 11 is connected to each unit, receives a signal from each unit, and outputs a signal to each unit. The processor 11 serves as the core of a computer that executes calculation and control necessary for calculation of CO₂. The processor 11 executes calculation and control to realize various functions based on a program such as system software, firmware, or application software stored in the auxiliary storage unit 13 or the like.

The main storage unit 12 includes a read only memory (ROM) and a random access memory (RAM). The ROM is a non-transitory computer-readable storage medium, stores a part or all of the programs described above, and also stores data or various setting values used when the processor performs various processing. The RAM is a working storage area, and temporarily stores processing data, etc. of the processor 11.

The auxiliary storage unit 13 is a non-transitory computer-readable storage medium, and is composed of, for example, at least one of an electric erasable programmable read-only memory (EEPROM), a hard disk drive (HDD), a solid state drive (SSD), or the like. The auxiliary storage unit 13 stores a part or all of the programs described above, and also stores data or various setting values used when the processor performs various processing. Furthermore, the auxiliary storage unit 13 stores management information acquired via the communication interface 14 or the like. In addition, the auxiliary storage unit 13 stores a CO₂ emission amount totalization database in which CO₂ emission amounts calculated by the processor 11 are accumulated.

The communication interface 14 communicates with each system to transmit and receive various kinds of information. The communication interface 14 also communicates with the information processing apparatus 8 via another system 7 to transmit and receive various kinds of information. The communication interface 14 communicates with the communication terminal 10, etc. via the communication network 9 to transmit and receive various kinds of information. For example, the communication interface 14 receives a power sales history from the management system 4 of each power retailer. The power sales history is information by customer, place of use, power source type, and time zone. The communication interface 14 also receives energy information including a power purchase history, a power consumption history, and a fuel consumption history from the energy management system 5 of each manufacturing plant. The power purchase history is information by power source type and by time zone. The power consumption history is information by device in the plant and by time zone. The fuel consumption history is information by device in the plant and by time zone. In addition, the communication interface 14 receives raw material information from the information output system 6 of the plant. If the raw material includes a virgin raw material, the raw material information includes information indicating that the material is a virgin raw material and a ratio of the virgin raw material to the raw material, and if the raw material includes a recycled raw material, the raw material information includes information indicating that the material is a recycled raw material and a ratio of the recycled raw material to the raw material.

The data retrieval unit 15 retrieves a CO₂ emission amount of a product or component from the CO₂ emission amount database based on a CO₂ emission amount retrieval request from the outside.

Based on user identification information included in the retrieval request, the user authentication system 16 authenticates the retrieval request if the user is authorized, and denies the retrieval request if the user is not authorized.

The input/output interface 17 receives an input from the input device 171, notifies the processor 11 of the input, and outputs display information to the display device 172 based on a display control signal or the like from the processor 11.

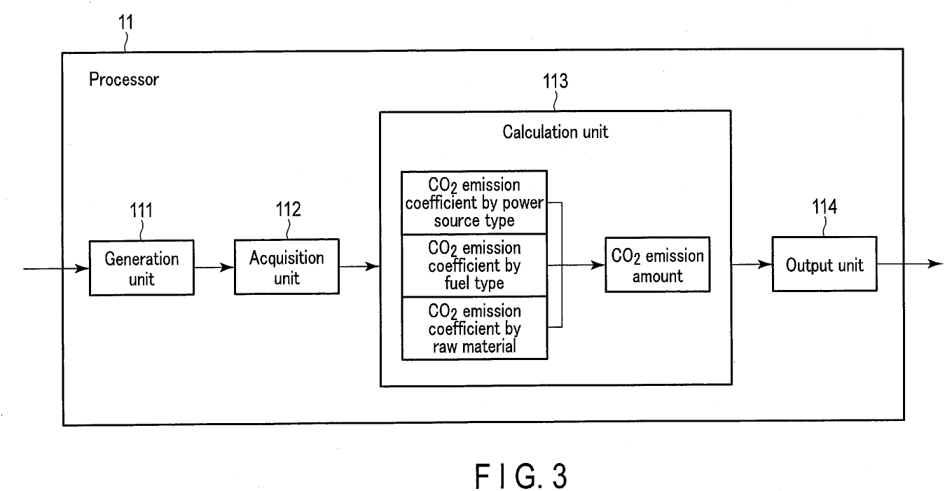

FIG. 3 is a functional block diagram showing an example of the processor of the information processing apparatus according to the embodiment.

As shown in FIG. 3, the processor 11 includes a generation unit 111, an acquisition unit 112, a calculation unit 113, and an output unit 114. The processor 11 realizes functions of these units by executing programs stored in at least one of the main storage unit 12 or the auxiliary storage unit 13. That is, the functions of these units are realized by cooperation between the processor 11 and the programs. These units may be realized by circuit configurations independent of the processor 11.

The generation unit 111 generates management information from the various kinds of information received by the communication interface 14, and the acquisition unit 112 acquires the management information generated by the generation unit 111. For example, the generation unit 111 generates the management information based on the raw material information transmitted from the information output system 6, the power sales history information transmitted from the management system 4 of each power retailer, and the power purchase history, power consumption history, and fuel consumption history transmitted from the energy management system 5 of each manufacturing plant. The management information is information including raw material information related to one or more kinds of raw materials of a product or component, power information related to one or more types of electric power used in a manufacturing process of the product or component among a plurality of types of electric power of different power generating systems, fuel information related to one or more kinds of fuels consumed in the manufacturing process of the product or component, etc. The power information used in the manufacturing process includes information related to power used by a machine tool, a conveying machine, and a transport vehicle, and includes identification information of the product or component, a type of electric power, an amount of electric power, and a time zone. The fuel information used in the manufacturing process includes information related to fuels used by the machine tool, conveying machine, and transport vehicle.

Based on the power information included in the management information, the calculation unit 113 calculates a CO₂ emission amount E1 emitted to obtain electric power used in manufacturing of the product or component. The calculation unit 113 calculates the CO₂ emission amount E1 based on the electric power of different power generating systems with different calculation methods. That is, the CO₂ emission amount E1 by power type is calculated based on a CO₂ emission coefficient by power type. For example, a CO₂ emission amount calculation coefficient for thermal power generation is set to a value greater than a CO₂ emission amount calculation coefficient for solar power generation. Thus, the CO₂ emission amount of the manufactured product or component is large if the ratio of the thermal power generation to the used power is high, and the CO₂ emission amount of the manufactured product or component is small if the ratio of the solar power generation to the used power is high.

In addition, the calculation unit 113 calculates a CO₂ emission amount E2 emitted to obtain the raw material used in manufacturing of the product or component based on the raw material information included in the management information. The calculation unit 113 calculates the CO₂ emission amount E2 based on a virgin raw material and a recycled raw material with different calculation methods. For example, a CO₂ emission amount calculation coefficient for the virgin raw material is set to a value greater than a CO₂ emission amount calculation coefficient for the recycled raw material. Thus, the higher the ratio of the virgin raw material to the raw material, the larger the CO₂ emission amount of the product or component manufactured from that raw material.

Further, the calculation unit 113 calculates a CO₂ emission amount E3 emitted through manufacturing of the product or component based on the fuel information included in the management information. The CO₂ emission amount calculation coefficient for each fuel differs depending on the kind of fuel.

In addition, the calculation unit 113 calculates a price of the product or component based on the CO₂ emission amount according to the type of electric power used in the manufacturing process. Further, the calculation unit 113 calculates a price of the product or component based on the CO₂ emission amount according to the type of electric power used in the manufacturing process and the CO₂ emission amount according to the kind of raw material. For example, the calculation unit 113 calculates the price of the product or component based on a CO₂ emission amount by using an environmental impact equivalent amount determined according to the CO₂ emission amount.

The output unit 114 outputs information related to the CO₂ emission amounts E1, E2, and E3. For example, the output unit 114 outputs the CO₂ emission amounts E1, E2, and E3 for each product or component, or outputs a sum of the CO₂ emission amounts E1, E2, and E3 for each product or component. The output CO₂ emission amounts E1, E2, and E3 are stored in the CO₂ emission totalization database of the auxiliary storage unit 13 or the like.

In addition, the output unit 114 outputs the price of the product or component calculated based on the CO₂ emission amount together with the information related to the CO₂ emission amounts E1, E2, and E3. The price of the product or component calculated based on the output CO₂ emission amount is stored in the CO₂ emission totalization database of the auxiliary storage unit 13 or the like.

The information processing apparatus 1 can provide information related to a substantive emission amount of CO₂ emitted in a manufacturing process of a product or component based on management information including power information, etc.

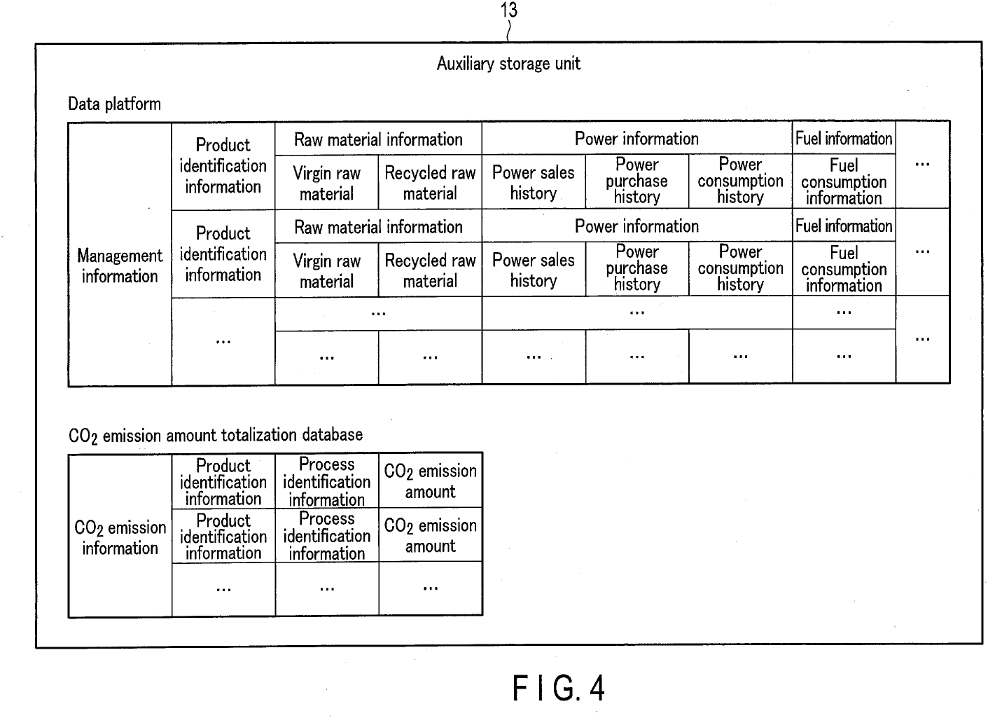

FIG. 4 is a diagram showing an example of a data platform, etc. stored in the auxiliary storage unit of the information processing apparatus according to the embodiment.

As shown in FIG. 4, the auxiliary storage unit 13 stores a data platform and a CO₂ emission amount database. The data platform includes management information generated by the generation unit 111, and the management information includes identification information of a product or component (abbreviated as product identification information in FIG. 4), raw material information, power information, fuel information, etc. The CO₂ emission amount database includes CO₂ emission information. The CO₂ emission information includes identification information of a product or component, process identification information, a CO₂ emission amount, etc. The process identification information is information for identifying a manufacturing process, a use process, a reuse process, etc.

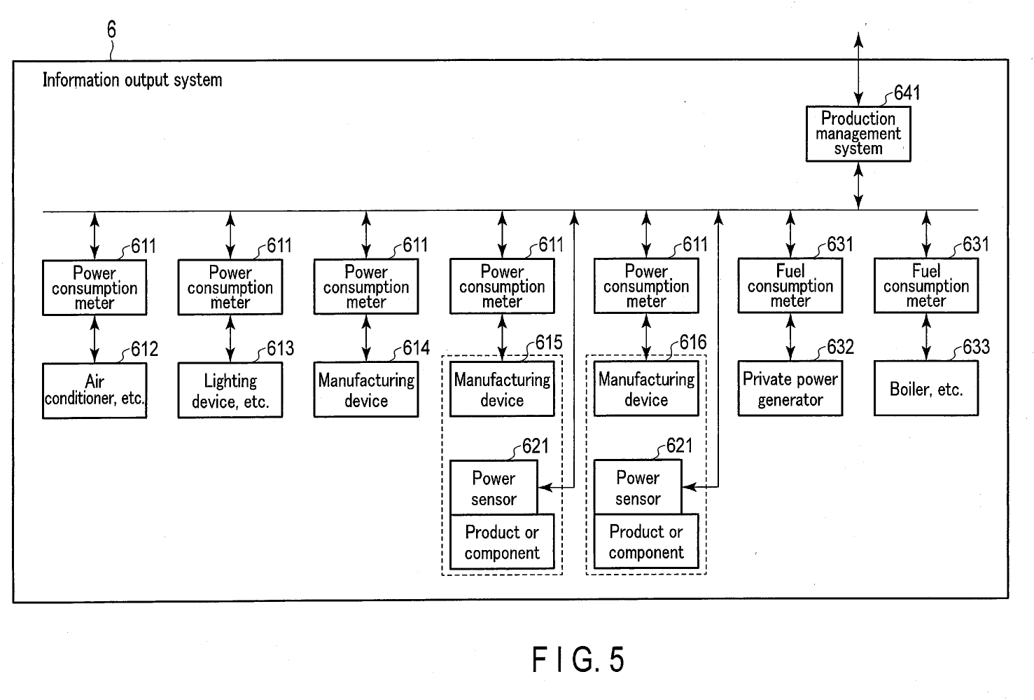

FIG. 5 is a block diagram showing an example of a schematic configuration of the information output system of the plant according to the embodiment.

As shown in FIG. 5, the information output system 6 outputs information including a time-synchronized time stamp. For example, the information output system 6 outputs a power consumption amount by time zone provided from power consumption meters 611 of an air conditioner 612 and a lighting device 613. The information output system 6 also outputs identification information of the product or component and a power consumption amount by time zone provided from power consumption meters 611 of manufacturing devices 614, 615, and 616. In addition, a power sensor 621 is attached to each product or component, and the information output system 6 outputs identification information of the product or component and a power consumption amount consumed by the product or component provided from the power sensor 621. Further, the information output system 6 outputs a fuel consumption amount by time zone provided from fuel consumption amount meters 631 of a private power generator 632 and a boiler 633.

A production management system 641 of the plant manages and outputs an operation time by product of each device in the plant.

### (Operation Example)

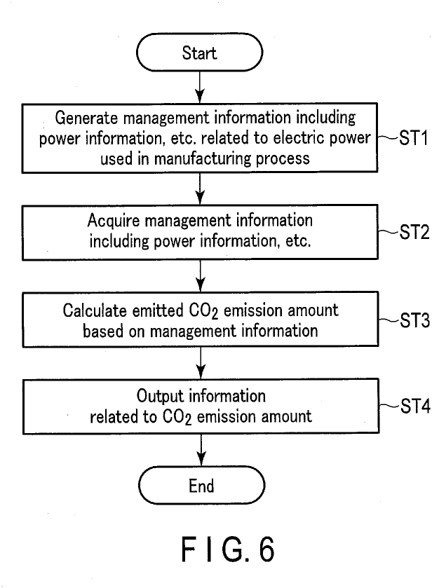

FIG. 6 is a flowchart showing an example of information processing including CO₂ emission amount calculation performed by the information processing apparatus according to the embodiment.

The generation unit 111 of the information processing apparatus 1 generates management information from various kinds of information received by the communication interface 14 (ST1). The management information includes raw material information related to one or more kinds of raw materials used in a manufacturing process of a product or component, power information related to one or more types of electric power selected from a plurality of types of electric power, fuel information related to one or more kinds of fuels selected from a plurality of kinds of fuels, etc.

The acquisition unit 112 acquires the management information generated by the generation unit 111 (ST2). In the present embodiment, a case in which the information processing apparatus 1 generates the management information will be described. However, in a case where an external server or the like different from the information processing apparatus 1 generates management information, the communication interface 14 acquires the management information generated by the external server or the like.

Based on the power information included in the management information, the calculation unit 113 calculates the CO₂ emission amount E1 emitted to obtain electric power used in manufacturing of the product or component (ST3). The calculation unit 113 also calculates the CO₂ emission amount E2 emitted to obtain a raw material used in manufacturing of the product or component based on the raw material information included in the management information. Further, the calculation unit 113 calculates the CO₂ emission amount E3 emitted through manufacturing of the product or component based on the fuel information included in the management information.

The output unit 114 outputs information related to the CO₂ emission amount E1 emitted to obtain the electric power used in manufacturing of the product or component (ST4). The output unit 114 also outputs information related to the CO₂ emission amount E2 emitted to obtain the raw material used in manufacturing of the product or component. In addition, the output unit 114 outputs information related to the CO₂ emission amount E2 emitted according to consumption of the fuel used in manufacturing of the product or component. The output unit 114 outputs the CO₂ emission amounts E1, E2, and E3 for each product or component, or outputs a total value of the CO₂ emission amounts E1, E2, and E3 for each product or component.

### (Supplementary Notes)

In the following, a supplementary description will be given of a method for calculating or estimating the CO₂ emission amount.

### <Method for Calculating or Estimating CO₂ Emission Amount>

A description will be given of an example of a method for calculating or estimating a CO₂ emission amount in each process of manufacturing, use, and reuse performed by the information processing system according to the embodiment.

For example, the following data are used as parameters to calculate and estimate the CO₂ emission amount.

### A) Product Number

A product number is a number for individually identifying that product or component itself. For example, the product number is assigned at the time of manufacturing planning.

### B) Direct Use Device Number

A direct use device number is a number for identifying a specific device (machine tool, robot, conveyor, or the like) that is directly used (occupied by the product or component) one by one throughout the whole process including manufacturing, use, collection, etc. of that product or component. For example, the direct use device number is assigned at the time of system construction and setting.

### C) Indirect Use Device Number

An indirect use device number is a number for identifying a device (a device requiring a power source or fuel, such as a power machine, an engine, a boiler, a computer, a communication device, a server on a data center, lighting, air conditioning, a transportation vehicle, or a storage battery) that is used indirectly (in common with other products or components) throughout the whole process including manufacturing, use, collection, etc. of the product or component. The indirect use device number is assigned at the time of system construction and setting.

### D) Operation Time

An operation time is a time from a time when each device or a product with product number a itself starts operation to a time (year, month, date, and time) when the operation is completed over the whole process including manufacturing, use, collection, etc. of the product number a. Note that an “operation time” is recorded for each series of operation steps not only at the time of manufacturing the product or component but also at the time of shipping and delivery, the time of use, the time of collection, etc.

### E) Usage Rate by Power Source

A usage rate by power source is a ratio of electric power supplied by a power retailer during a time zone by power source type (thermal power, hydraulic power, solar power, wind power, biomass, nuclear power, etc.). The usage rate by power source is acquired from contract information between a power retailer and a consumer (manufacturer, user, or the like). Since the usage rate by power source changes depending on a time zone, time, a type of power usage contract, etc. due to a management policy, etc. of the contracted power retailer, values thereof are managed, recorded, and held in time series (past usage rates by power source are held without being deleted in order to ensure traceability).

### F) CO₂ Emission Amount Coefficient by Power Source

A CO₂ emission amount coefficient by power source is a coefficient set according to a CO₂ emission amount per 1 kwh of electric power by power source type. The CO₂ emission amount coefficient by power source is acquired from materials disclosed by a power retailer or materials of an average value of CO₂ emission amounts by power source published by the Ministry of Economy Agency for Natural Resources and Energy, etc. Since the CO₂ emission amount coefficient by power source changes due to technical evolution (a performance of a power generation facility used by a power generation company), a place of power use, a power transmission distance, a power transmission/distribution efficiency, etc., values thereof are managed, recorded, and held in time series (past coefficients are also held without being deleted in order to ensure traceability).

### G) Power Consumption Amount

A power consumption amount is an amount of electric power consumed by each device/machine during an operation time d (including an amount of electric power consumed by that product or component itself). The power consumption amount is measured by a sensor built into the device and machine or an externally attached electric energy meter, and is managed in association with the product number a, a direct use device number b, and an indirect use device number c.

### H) CO₂ Emission Amount Coefficient by Fuel

A CO₂ emission amount coefficient by fuel is a coefficient according to a CO₂ emission amount per unit consumption amount of each fuel (heavy oil, gasoline, wood chips, etc.). The CO₂ emission amount coefficient by fuel is calculated from an element amount (chemical formula, etc.) of the fuel and materials disclosed by the government or academic institutions.

### I) Fuel Consumption Amount

A fuel consumption amount is a type and a usage amount of fuel consumed by each device during the operation time d (including fuel consumed by the product or component itself). The fuel consumption amount is measured by a sensor built into the device and machine, an externally attached fuel flowmeter, or the like, and is managed in association with the product number a, the direct use device number b, and the indirect use device number c.

### J) Product CO₂ Emission Amount

A product CO₂ emission amount is an emission amount of CO₂ generated due to consumption of electric power and fuel by the product number a itself during the operation time d. The product CO₂ emission amount is a sum of a CO₂ emission amount due to power consumption by power source type and a CO₂ emission amount due to fuel consumption by fuel type. The CO₂ emission amount due to power consumption by power source type is calculated by multiplying a consumed power amount (kwh) by a usage rate by power source e to calculate a power consumption amount by power source type, multiplying each value by the CO₂ emission amount coefficient by power source f, and summing the obtained values. The CO₂ emission amount due to fuel consumption by fuel type is obtained by multiplying a fuel consumption amount i by a CO₂ emission amount coefficient by fuel h. The product CO₂ emission amount is calculated by acquiring data from a sensor built into a product or component, an externally attached electric power and fuel consumption meter, or the like, and is managed in association with the product number a.

### K) Direct Use Device CO₂ Emission Amount

A direct use device CO₂ emission amount is a total amount (a calculation method is the same as j) of CO₂ emitted by the direct use device b used over the whole process including manufacturing, use, collection, etc. of the product number a during the operation time d. The direct use device CO₂ emission amount is calculated by acquiring data using a sensor built into each device, an externally attached electric power and fuel consumption meter, or the like, and is managed in association with the product number a.

### 1) Other Product Direct Use Device CO₂ Emission Amount

An other product direct use device CO₂ emission amount is a sum (a calculation method is the same as j) of a CO₂ amount emitted due to power and fuel consumption of another direct use device occupied for manufacturing and collection of another product or component in the same plant (in the case of manufacturing and collection) and a CO₂ amount emitted due to power and fuel consumption of another direct use device occupied for use of another product or component in a finished product (e.g., a passenger car, an office building, etc.) constituted by a product or component (in the case of use), during the operation time d. The other product direct use device CO₂ emission amount is calculated by acquiring data using a sensor built into each device, an externally attached power and fuel consumption meter, or the like, and is managed in association with the product number a.

### M) Indirect Use Device CO₂ Emission Amount

An indirect use device CO₂ emission amount is a total amount (a calculation method is the same as j) of CO₂ emitted by the indirect use device c during the operation time d. The indirect use device CO₂ emission amount is calculated by acquiring data using a sensor built into each device, an externally attached power and fuel consumption meter, or the like, and is managed in association with the product number a.

### N) Product or Component CO₂ Emission Amount

A product or component CO₂ emission amount is calculated as follows. First, a coefficient for appropriately distributing (assigning) an indirect use device CO₂ emission amount 1 used throughout the whole process including manufacturing, use, collection, etc. as a CO₂ emission amount of that product or component for each discretionary operation time d to be totaled is calculated by, for example, the following formula. k/(k + 1)

Using this coefficient, a total amount of CO₂ emitted over the whole process including manufacturing, use, collection, etc. of that product or component for each operation time d is calculated by the following formula. J + k + {m × k/(k + 1)}

According to the above-described method, the information processing system according to the embodiment finely analyzes and totalizes a CO₂ emission amount until all products or components are completed from raw materials through processes such as processing, forming, and assembling, and then are inspected, shipped, delivered, used, collected, reused, and recycled, by process, device used, power source used, time, etc. for each and every product or component.

### <Selection of Power Type for Each Process>

For example, the energy management system 5 selects and uses inexpensive electric power such as thermal power with a large amount of CO₂ emission for a process requiring relatively large electric power, and selects and uses expensive electric power such as solar power with a small amount of CO₂ emission for a process requiring small electric power.

As another example, the energy management system 5 mainly selects and uses electric power generated by solar power or wind power in a daytime time zone or a time zone in which wind power is strong, and mainly selects and uses electric power generated by thermal power, nuclear power, or the like in a nighttime time zone.

For example, the energy management system 5 selects one or more power sources from among a plurality of types of power sources such as thermal power, hydraulic power, solar power, wind power, biomass, and nuclear power based on the following information.
Day rate (yen/kwh) of power source type by time zone (date and time)
Future reservation rate (N hours advance reservation rate yen/kwh) for each power source type by time zone (date and time)
Maximum providable capacity (kw) for each power source type by time zone (date and time) and its achievement probability (%)
Minimum provision guaranteed capacity (kw) for each power source type by time zone (date and time)
Average provision amount (kw) for each power source type by time zone (date and time)
Power source type of alternative provision power if power generation amount (suppliable amount) of each power source (in particular, solar power or wind power) by time zone (date and time) falls below prediction (e.g., priority order 1 = hydraulic power, 2 = solar power, 3 = wind power, 4 = thermal power, 5 = nuclear power)
CO₂ emission amount (g/kwh) associated with processing from power generation to power transmission of power source type
Remaining battery level (kwh) of storage battery owned by user (plant or the like) and power source type (thermal power, solar power, hydraulic power, private power generation, or the like) of procurement source of stored power
Operable time of private power generator owned by user (plant or the like) (calculated from inventory amount of fuel)

The information processing apparatus 1, instead of the energy management system 5, may select a power source. As described above, power sources having different CO₂ emission amounts are selected by the energy management system 5 or the information processing apparatus 1 based on the various conditions, but the information processing apparatus 1 can accurately calculate, record, trace, and verify the CO₂ emission amount regardless of which power type is selected and used.

### <Calculation Method of CO₂ Emission Amount for Each Power Type>

For example, the information processing apparatus 1 stores a CO₂ emission amount per unit time by power type in advance, measures a use time and a use amount for each selected power type, and calculates a CO₂ emission amount required for manufacturing a product or component according to the measurement values and the CO₂ emission amount per unit time.

The information processing apparatus 1 also calculates a CO₂ emission amount by power type based on a CO₂ emission coefficient by power type. The information processing apparatus 1 acquires a CO₂ emission amount (g/kwh) required for processing from power generation to power transmission by power source type from a report of a power company (power generation/power transmission and distribution/power retailer), the government, etc., and registers a value thereof as a CO₂ emission coefficient by power retailer and power source type. The information processing apparatus 1 updates this CO₂ emission coefficient every time information from the power company and information of the government report, etc. are updated.

If a manufacturing device or a product itself to be manufactured actually consumes electric power, an electric power meter or an electric power sensor built in or externally attached to the device or product measures a power consumption amount by time and outputs a value thereof to the energy management system 5.

For example, if the energy management system 5 receives electric power of a plurality of types of power sources (e.g., solar power, wind power, and thermal power) from a power retailer in a predetermined time zone, the energy management system 5 sets, as a variable coefficient, which type of power source power is allocated to each device in the plant in which priority order and in what ratio, and logically calculates which device consumes which type of power source power in the predetermined time zone. For example, a sum of power consumption amounts of all devices or a sum of power consumption amounts of all products or components is logically equal to a total power amount received by the entire plant, but a deviation occurs due to a power transmission loss, etc. in the plant. Therefore, the power lost due to the power transmission loss, etc. in the plant is adjusted by being distributed according to a ratio of power consumption amounts of the devices.

The energy management system 5 creates consumption amount detailed data by power source type on amounts of electric power actually consumed by each device and the product itself. The information processing apparatus 1 multiplies each value by the coefficient (g/kwh) of the CO₂ emission amount involved in processing from power generation to power transmission by power source type described above to calculate an emission amount of CO₂ emitted by each device and the product itself in that time zone. A total sum thereof is logically equal to a CO₂ emission amount of a total power amount received by the plant in that time zone, but since a deviation occurs due to a power transmission loss, etc. in the plant, a CO₂ emission amount due to the power lost in the plant is adjusted by distributing according to a ratio of CO₂ emission amounts of the devices.

Further, the information processing apparatus 1 calculates a CO₂ emission amount due to combustion of fuel used in the plant to produce energy other than received power (fuel for a boiler, a private power generator, or the like) from a fuel consumption amount for each device and a CO₂ emission amount coefficient by fuel.

The information processing apparatus 1 divides the calculated CO₂ emission amount of each device into a CO₂ emission amount of a device directly used for manufacturing the product, a CO₂ emission amount of a device directly used for manufacturing another product, and a CO₂ emission amount of a device commonly used in the plant, distributes the CO₂ emission amount of the device commonly used in the plant as an indirect CO₂ emission amount of the device directly used for manufacturing, and sums them up to calculate a CO₂ emission amount emitted through manufacturing of that product.

Regarding the electric power received and the fuel burned in the plant site, those used for applications completely unrelated to manufacturing of products (e.g., a surplus of the electric power produced in the plant site is supplied to nearby hospitals and companies) may be excluded from the subject of the CO₂ emission amount distributed to the products produced in the plant.

### <Calculation of CO₂ Emission Amount Based on Power Usage History>

It is presumed that the power usage history changes for each process and further for each time zone, and a method for calculating the CO₂ emission amount for each process or the entire manufacturing process according to the changes will be described.

According to the above-described method, a power consumption amount of each product itself is measured by an externally attached power meter or a built-in power sensor for each device by time zone (for each year, month, date, and time), and a ratio by power source type of electric power received from a power retailer in that time zone is recorded. Thus, a CO₂ emission amount for each process, each time zone, and each device is detected and distributed and totaled as a CO₂ emission amount emitted for manufacturing each product.

### <Power Use Certification>

An example of a mechanism for automatically grasping, verifying, and certifying when, where, from which electric power company, and what kind of electric power is used for each device and machine used for manufacturing, conveying, and transporting a product or component will be described.

The energy management system 5 acquires and records a value of a combination ratio of power source types in each time zone from a power retailer based on a contract with the power retailer. The information processing apparatus 1 acquires a “power procurement and transmission history by power source by customer (retailer)” managed by the management system 3 of each power transmission company and information of a certificate (e.g., green power certificate, etc.) inspected and certified by a third party system online or offline and registers them in the platform, and collates with the value of the combination ratio of power source types provided by the retailer to check whether there is tampering, forgery, an error, etc.

According to the embodiment described above, an information processing apparatus, an information processing method, and a program thereof that can provide information related to a substantive emission amount of CO₂ emitted in a manufacturing process of a product or component can be provided.

In short, this invention is not limited to the above-described embodiment as it is, and can be embodied by modifying the constituent elements without departing from the gist of the invention in an implementation stage. Further, various inventions can be formed by appropriately combining a plurality of constituent elements disclosed in the above-described embodiment. For example, some constituent elements may be deleted from the constituent elements indicated in the embodiment. Furthermore, constituent elements in different embodiments may be appropriately combined.

REFERENCE SIGNS LIST

| | |
|---|---|
| 1: | information processing apparatus |
| 2: | management system of power generation company |
| 3: | management system of power transmission company |
| 4: | management system of power retailer |
| 5: | energy management system of manufacturing plant |
| 6: | information output system of plant |
| 7: | another system |
| 8: | information processing apparatus |
| 9: | communication network |
| 10: | communication terminal |
| 11: | processor |
| 12: | main storage unit |
| 13: | auxiliary storage unit |
| 14: | communication interface |
| 15: | data retrieval unit |
| 16: | user authentication system |
| 17: | input/output interface |
| 111: | generation unit |
| 112: | acquisition unit |
| 113: | calculation unit |
| 114: | output unit |
| 171: | input device |
| 172: | display device |
| 611: | power consumption meter |
| 612: | air conditioner |
| 613: | lighting device |
| 614, 615, and 616: | manufacturing device |
| 621: | power sensor |
| 631: | fuel consumption meter |
| 632: | private power generator |
| 633: | boiler |
| 641: | production management system of plant |

1. An information processing apparatus comprising:
an acquisition unit configured to acquire management information including power information related to one or more types of electric power used in a manufacturing process of a product or component among a plurality of types of electric power of different power generating systems;
a calculation unit configured to calculate a first carbon dioxide emission amount emitted through manufacturing of the product or component based on the power information included in the management information; and
an output unit configured to output information related to the first carbon dioxide emission amount.

2. The information processing apparatus according to claim 1, wherein the management information includes the power information related to electric power used by a machine tool, a conveying machine, and a transport vehicle in the manufacturing process of the product or component.

3. The information processing apparatus according to claim 1, wherein the power information includes identification information of the product or component, and a type and an amount of the electric power used in the manufacturing process of the product or component.

4. The information processing apparatus according to claim 1, wherein the power information includes a use time zone of the electric power used in the manufacturing process of the product or component.

5. The information processing apparatus according to claim 1, wherein
the management information includes raw material information related to one or more kinds of raw materials of the product or component,
the calculation unit is configured to calculate a second carbon dioxide emission amount emitted to obtain the raw material based on the raw material information included in the management information, and
the output unit is configured to output information related to the first carbon dioxide emission amount and the second carbon dioxide emission amount.

6. The information processing apparatus according to claim 5, wherein
the raw material information includes information indicating that the raw material is a virgin raw material and information indicating that the raw material is a recycled raw material, and
the calculation unit is configured to calculate the second carbon dioxide emission amount based on the virgin raw material and the recycled raw material with different calculation methods.

7. The information processing apparatus according to claim 1, wherein
the calculation unit is configured to calculate a price of the product or component based on the first carbon dioxide emission amount, and the output unit is configured to output the price of the product or component.

8. The information processing apparatus according to claim 5, wherein
the calculation unit is configured to calculate a price of the product or component based on the first carbon dioxide emission amount and the second carbon dioxide emission amount, and
the output unit is configured to output the price of the product or component.

9. An information processing method comprising:
acquiring management information including power information related to one or more types of electric power used in a manufacturing process of a product or component among a plurality of types of electric power of different power generating systems;
calculating a first carbon dioxide emission amount emitted through manufacturing of the product or component based on the power information included in the management information; and
outputting information related to the first carbon dioxide emission amount.

10. A non-transitory computer-readable medium recording a program for causing a computer to execute:
acquiring management information including power information related to one or more types of electric power used in a manufacturing process of a product or component among a plurality of types of electric power of different power generating systems;
calculating a first carbon dioxide emission amount emitted through manufacturing of the product or component based on the power information included in the management information; and
outputting information related to the first carbon dioxide emission amount.
